(19) United States
(12) Patent Application Publication
(10) Pub. No.: US 2015/0264785 A1
(43) Pub. Date: Sep. 17, 2015

(54) METHOD FOR OPERATING A LAMP UNIT FOR GENERATING ULTRAVIOLET RADIATION AND SUITABLE LAMP UNIT THEREFOR

(71) Applicant: HERAEUS NOBLELIGHT GMBH, Hanau (DE)

(72) Inventor: Josef Zoltan Lott, Hamburg (DE)

(21) Appl. No.: 14/433,895

(22) PCT Filed: Sep. 12, 2013
(86) PCT No.: PCT/EP2013/068911

§ 371 Date: Apr. 7, 2015

(30) Foreign Application Priority Data
Oct. 8, 2012 (DE) 10 2012 109 519.1

(51) Int. Cl. H05B 41/39

(52) U.S. Cl. CPC H05B 41/39

(57) ABSTRACT

A lamp unit includes a gas discharge lamp with an essentially constant lamp current applied thereto, and a temperature control element adjustable via a control unit, and being a cooling element for cooling the gas discharge lamp. A method for operating the lamp unit includes: (a) determining an actual value of a lamp voltage by a voltage sensor, (b) transmitting the actual value of the lamp voltage to the control unit, (c) comparing the actual value with a desired value of the lamp voltage by the control unit, and (d) outputting a control signal via the control unit to the cooling element for setting the cooling power.

### CROSS-REFERENCE TO RELATED APPLICATIONS

This application is a Section 371 of International Application No. PCT/EP2013/068911, filed Sep. 12, 2013, which was published in the German language on Apr. 17, 2014, under International Publication No. WO 2014/056670 A1 and the disclosure of which is incorporated here-in by reference.

### BACKGROUND OF THE INVENTION

The present invention relates to a method for operating a lamp unit for generating ultra-violet radiation, comprising a gas discharge lamp having a discharge chamber accessible for a mercury charge, an electronic ballast, and a temperature control element which can be adjusted by a control unit for controlling the temperature of the gas discharge lamp. The gas discharge lamp is operated with a lamp current and a lamp voltage.

The present invention also relates to a lamp unit for performing the method, comprising a gas discharge lamp with a discharge chamber accessible for a mercury charge, an electronic ballast, and a temperature control element which can be adjusted by a control unit for controlling the temperature of the gas discharge lamp.

Known gas discharge lamps for generating ultraviolet radiation have a tubular discharge container made of quartz glass and a discharge chamber with two electrodes arranged within the discharge chamber. The discharge chamber is filled with a filler gas, for example, a noble gas.

In gas discharge lamps, the emission output depends, in particular, on the mercury partial pressure in the discharge chamber. To enable higher operating temperatures, the mercury is used in many gas discharge lamps in the form of a solid amalgam alloy in the discharge chamber. In the discharge chamber, an equilibrium is set between the liquid or solid mercury in the mercury charge and the gaseous mercury present in the discharge chamber. The binding of the mercury in the amalgam influences the temperature dependency of the mercury partial pressure in the discharge chamber and basically contributes to the fact that, for gas discharge lamps having an amalgam charge, high outputs and power densities can be achieved.

However, in a gas discharge lamp having an amalgam charge, the equilibrium between the mercury bound in the amalgam and the free mercury depends on the operating temperature of the gas discharge lamp, in particular on the temperature of the amalgam charge. There exists an optimum operating temperature at which the emission output of the gas discharge lamp is at a maximum.

The parameters of the gas discharge lamp influencing the operating temperature, for example, the nominal voltage and the nominal current, are indeed designed with respect to the specified ambient conditions for an adequate emission output. This applies, however, only as long as the actual ambient conditions correspond approximately to the specified ambient conditions. The operating temperature of a gas discharge lamp is often influenced in practice by the ambient conditions. Excess heating occurs, for example, at a high ambient air temperature or when the gas discharge lamp is housed in a narrow space. This can have the result that the gas discharge lamp is no longer operated at its operational optimum.

To ensure a maximum emission output that is independent of the ambient conditions, it has been proposed to set the temperature of the amalgam charge via a temperature control element.

For example, from German published patent application DE 101 29 755 A1, an operating device is known for a T5 fluorescent tube having a temperature control location in which, in the area of the temperature control location, a temperature sensor is arranged for determining the temperature. As a function of the determined temperature, the temperature of the temperature control location is controlled by a controllable coil heating element, wherein an optimum mercury vapor pressure is ensured in the fluorescent tube.

In addition, from International Publication No. WO 2005/102401 A2, a sterilization device is known having a UV lamp in which, for monitoring the surface temperature of the lamp bulb of the UV lamp, a temperature sensor is provided. The temperature sensor is mounted on the lamp bulb. In addition, the sterilization device also comprises a UV sensor for measuring the UV radiation emission of the UV lamp. To ensure an optimum operating temperature and emission output of the lamp, it is proposed therein that the lamp be cooled or heated as a function of the determined temperature by a fan unit.

However, a temperature sensor arranged on the surface of a lamp only detects the temperature changes of the surface. These take place relatively slowly, so that regulation of the mercury partial pressure via the surface temperature has a certain amount of delay.

In addition, determining the radiation emission with a UV sensor is also suitable for regulating and optimizing the emission output only under certain conditions, because the one-time measurement of a non-maximum emission output does not allow any conclusion to be drawn on the cause of the non-maximum emission output. Possible reasons for a non-maximum emission output could be a lamp having a temperature that is either too high or too low, so that only on the basis of other measured lamp parameters could it be decided whether the lamp must be cooled or heated to increase the emission output. A regulation of the radiation emission using a UV sensor is therefore dependent on the use of another sensor—for example a temperature sensor—and is thus also subject to a delay.

### BRIEF SUMMARY OF THE INVENTION

Therefore, the invention is based on the object of providing a method for operating a lamp unit having a high emission output, that ensures a quick adaptation to changed operating conditions, that enables a simple and economical operation of the lamp unit, and that also enables operation of the lamp unit independent of its structural form.

The invention is further based on the object of providing a lamp unit that can also be operated with a high emission output at changing operating conditions and is also simple and economical to produce.

With respect to the method, this object is achieved according to the invention, starting from a method of the type mentioned above, in that, during an operating phase, an essentially constant lamp current is applied to the gas discharge lamp, in that the temperature control element is a cooling element for cooling the gas discharge lamp, and in that the method has the following processing steps:

(a) determining an actual value of the lamp voltage by a voltage sensor,

(b) transmitting the actual value of the lamp voltage to the control unit,

(c) comparing the actual value with a desired value of the lamp voltage by the control unit, and

(d) outputting a control signal by the control unit to the cooling element for adjusting the cooling power.

The emission output of a gas discharge lamp is primarily dependent on the temperature of the plasma generated by the gas discharge lamp. An optimum emission output is obtained if the gas discharge lamp has an optimum plasma temperature. However, because the plasma temperature is not accessible for a direct measurement, gas discharges of conventional lamp units are controlled during operation either to an optimum temperature, for example of the lamp bulb, or to an optimum emission output. Conventional lamp units have a temperature sensor for determining the temperature or a UV sensor for determining the emission output, as well as a temperature control element, which can be controlled as a function of the determined temperature or UV emission output. These two measurement parameters, however, enable only an indirect inference about the plasma temperature of the gas discharge lamp. Its value is also dependent on other influencing parameters, for example the geometry of the lamp unit or the air guidance within the lamp unit.

Therefore, in the method according to the invention, an indirect detection of the plasma temperature of the gas discharge lamp by an external temperature sensor or a UV sensor is eliminated. Instead, it is provided that the determination of the operating temperature of the gas discharge lamp is realized by a voltage sensor, which determines the voltage applied to the gas discharge lamp while the lamp unit is operating. This voltage measurement enables, on the one hand, a direct conclusion to be made about the current plasma temperature. On the other hand, this voltage measurement is independent of the geometry of the lamp unit, so that an optimum operation of the lamp unit is enabled independent of the structural form of the lamp unit. Because the temperature sensor or UV sensor is eliminated, this arrangement also enables an economical and simple operating method. Furthermore, the relatively slow temperature measurement or emission output measurement is eliminated. These are replaced according to the invention by a voltage measurement with less delay, which enables a quick adaptation of the lamp operating parameters to temperature changes of the gas discharge lamp and thus short response times.

The method according to the invention assumes the application of an essentially constant lamp current to the gas discharge lamp. An essentially constant lamp current is understood to be a lamp current that deviates from its nominal value by at most ±2% during the operation of the lamp.

In a gas discharge lamp operating at a constant lamp current, the corresponding lamp voltage is mainly dependent on the plasma temperature of the gas discharge lamp. The reason for this is the mercury partial pressure in the discharge container of the gas discharge lamp, which increases exponentially with increasing temperature, so that a lower operating voltage goes along with an increased mercury partial pressure. Consequently, the optimum operating temperature corresponds to a lamp voltage whose setting leads to an operating temperature corresponding to the lamp voltage.

To set the operating temperature according to the invention, first the current lamp voltage, that is the actual value of the lamp voltage, is determined by a voltage sensor and is then transmitted to the control unit. Transmitting the actual value can be performed by the control unit or by the voltage sensor. In the simplest case, the control unit reads out the actual values of the voltage sensor.

The control unit compares the actual value with a previously provided desired value of the lamp voltage and determines a possible deviation.

To determine the desired value of the lamp voltage, the emission output of the gas discharge lamp is determined with a UV sensor as a function of the lamp voltage, wherein, as a desired value, the lamp voltage is selected at which the emission output of the gas discharge lamp is at a maximum. The desired value of the lamp voltage can be determined generally for all lamps of a certain type or individually for each lamp.

To set the operating temperature or the lamp voltage, finally a cooling element for cooling the gas discharge lamp is provided. For setting the operating temperature as a function of the determined deviation, the control unit outputs to the cooling element a control signal regulating the cooling power. The control signal can vary as a function of the magnitude of the deviation.

In one advantageous modification of the method according to the invention, it is provided that the electronic ballast includes the voltage sensor and determines the actual value of the lamp voltage.

The lamp unit has an electronic ballast, with which the gas discharge lamp is operated. A ballast having a voltage sensor enables a simple, favorable, and compact structural form of the lamp unit.

Optimum emission values are achieved if the desired value of the lamp voltage is determined individually at the factory for each gas discharge lamp, and then the individually determined desired value is stored in a memory element connected to the gas discharge lamp, wherein this memory element is read out by the control unit when the gas discharge lamp is switched on.

The optimum operating temperature and thus also the lamp voltage can also vary depending on the production conditions between structurally identical gas discharge lamps. A desired value for the lamp voltage determined individually at the factory for each gas discharge lamp enables an optimum operation of the individual gas discharge lamps with high emission output. Because the individual desired value is stored in a memory element connected to the gas discharge lamp, the memory element is connected to the individual gas discharge lamp such that the desired value can be made available to the control unit when the gas discharge lamp is switched on. In addition, such a memory element enables an automatic desired value adaptation when a lamp is replaced. Preferably, the memory element is an electronic memory element, for example an EEPROM or PROM memory module. The desired value of the lamp voltage could also be designed as a machine readable label on the lamp, preferably on the lamp socket.

In an alternative embodiment, it is provided that the gas discharge lamp is labeled with the desired value of the lamp voltage, wherein the desired value is provided to the control unit once by manual entry of the desired value when the lamp is replaced.

It has proven effective if the memory element is an electronic memory element and if the memory element is read out when the gas discharge lamp is turned on.

Electronic memory elements have two limiting temperatures, namely a maximum storage temperature and a maximum operating temperature. The maximum storage temperature specifies up to what temperature the electronic memory element can be stored without loss of quality. The maximum operating temperature describes the maximum temperature at which the memory element can be operated without faulty functioning.

Preferably, the memory element temperature is below 150° C. during the operation of the gas discharge lamp. Temperatures below 150° C. do not negatively affect the quality of the memory element.

Temperatures above 125° C. can negatively affect the functionality of electronic memory elements. The memory element is read out at temperatures below 125° C. The memory element is read out when the gas discharge lamp is switched on, so that the temperature of the memory element is less than 125° C. during the read out process. This prevents faulty functioning of the memory element.

A memory element connected to the gas discharge lamp is usually heated during the operation of the gas discharge lamp. The temperature of the memory element depends on its spatial position with respect to the gas discharge lamp. Preferably, the memory element is located in or on the socket of the gas discharge lamp. A memory element arranged in this way can be easily connected to the electrical power supply of the lamp, since the cables for electrical power supply of the lamp are also guided into the socket.

It has proven favorable if the actual value of the lamp voltage is determined at regular time intervals, preferably at a frequency from 1 min⁻¹ to 10 min⁻¹ when the lamp unit is operating.

The regular determination of the actual value of the lamp voltage enables a continuous adaptation of the cooling power to the current operating state of the gas discharge lamp. If the determination of the actual value of the lamp voltage takes place at a frequency of less than 1 min⁻¹, the cooling power can be adapted only slowly to changed operating conditions. If there is a time interval of greater than one minute between two measurements of the actual value of the lamp voltage, the UV emission output can decrease relatively significantly, which can negatively affect the irradiation result. Because the lamp voltage also reacts with a certain amount of delay to a change of the cooling power, a measurement frequency of greater than 10 min⁻¹ shows no significant improvement.

In one modification of the method that is also preferred, it is provided that the gas discharge lamp is continuously cooled by the cooling unit during the operation of the lamp unit.

A continuous cooling of the gas discharge lamp has the advantage that, due to the adaptation of the cooling power, the gas discharge lamp can be heated as well as cooled. A reduction of the cooling power causes the gas discharge lamp to heat up, and an increase of the cooling power leads to a lower temperature of the gas discharge lamp.

It has proven effective if the gas discharge lamp is cooled with an air flow generated by the cooling element.

A cooling element that generates an air flow is, for example, a ventilator, a blower, or a fan. Because these cooling elements use air for cooling, they are flexibly usable. A method in which such a cooling element is used can be performed economically.

With respect to the lamp unit for performing the method, the object stated at the outset is achieved according to the invention, starting from a lamp unit of the type mentioned in the introduction, in that the temperature control element is a cooling element for cooling the gas discharge lamp, in that a voltage sensor is provided for determining the actual value of a lamp voltage, and wherein the control unit has an input on which the actual value of the lamp voltage is applied as an input signal.

Such a lamp unit is suitable for use in the method described above. Because a voltage sensor is provided that determines the actual value of the lamp voltage, this actual value can be used as the basis for controlling the cooling power of the cooling element. The control unit has, accordingly, an input for the actual value of the lamp voltage. The output signal of the control unit generated on the basis of the actual value of the lamp voltage is used finally for setting the cooling power of the cooling element.

It has proven effective if the voltage sensor is integrated into the electronic ballast and that the electronic ballast has an output for the output of the actual value of the lamp voltage.

The gas discharge lamp is operated using an electronic ballast. An electronic ballast having integrated voltage sensor—compared with a device without this sensor—can be produced without significant expense or high extra costs and contributes to a compact structural form of the lamp unit.

In one advantageous construction of the lamp unit according to the invention, it is provided that the gas discharge lamp has an electronic memory element in which the desired value of the lamp voltage is stored.

Electronic memory elements are, for example, EEPROM or PROM storage modules. An electronic memory element connected to the gas discharge lamp ensures that the desired value of the lamp voltage can be provided to the control unit when the gas discharge lamp is switched on. The memory element also enables an automatic adjustment of the desired value, for example when a lamp is replaced.

It has proven effective if the memory element is arranged in the area of the socket of the gas discharge lamp.

A memory element arranged in the socket area of the gas discharge lamp can be easily connected to an electrical power supply of the lamp, since the cables for the electrical power supply of the lamp are already guided through the socket.

In one alternative, likewise preferred embodiment, the memory element is integrated into a connector plug of the gas discharge lamp.

The gas discharge lamp has a connector plug provided for contacting a power supply. With a memory element integrated in the connector plug, a simple electrical contacting of the connector element and a simple read out of the memory element are enabled.

In another advantageous construction of the device according to the invention, it is provided that the gas discharge lamp has labeling that defines the desired value of the lamp voltage.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram of a lamp unit for generating ultraviolet radiation having a low pressure amalgam radiator, and

FIG. 2 is a graphical representation in which the UV emission and the lamp voltage of the low pressure amalgam radiator are shown as a function of the cooling air temperature.

### DETAILED DESCRIPTION OF THE INVENTION

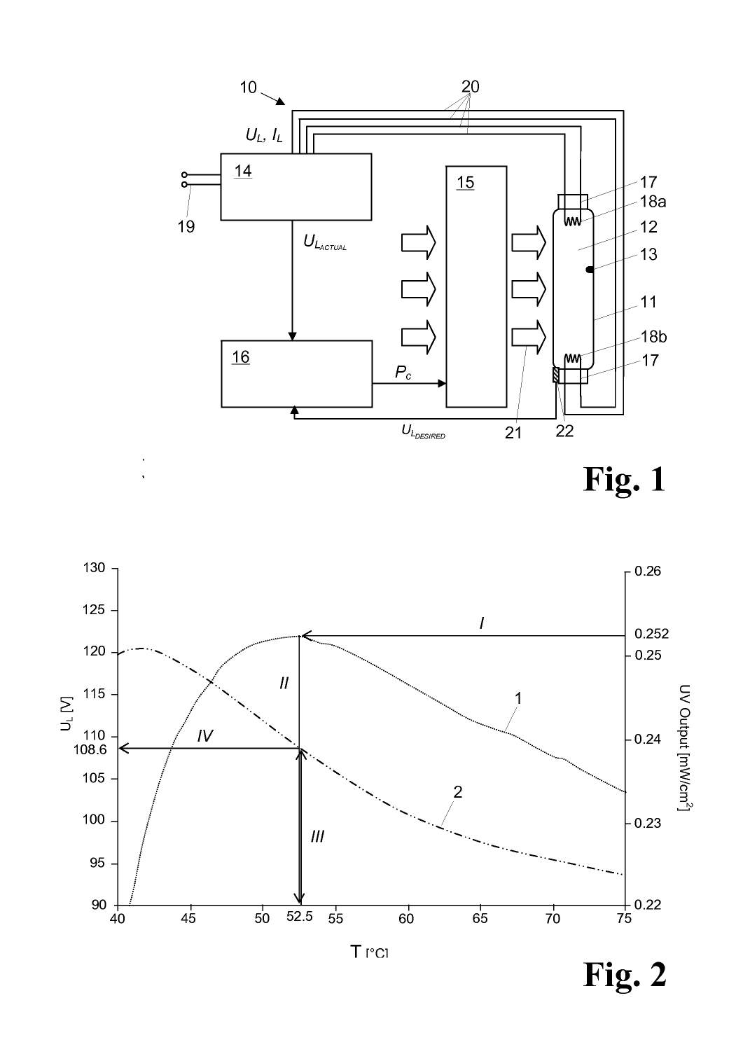

FIG. 1 shows a lamp unit for generating ultraviolet radiation, which is designated overall with reference numeral 10. The lamp unit is composed of a low pressure amalgam radiator 11, an electronic ballast 14 for the low pressure amalgam radiator 11, an axial fan 15 for cooling the low pressure amalgam radiator 11, and a control unit 16 for the axial fan 15. In one alternative embodiment (not shown), a radial fan is provided instead of the axial fan 15.

The low pressure amalgam radiator 11 comprises a tubular lamp made of quartz glass, which is closed at both ends with pinched sections 17, through which a power supply 18 is guided. Within and at opposite ends of the tubular lamp, two coil-shaped electrodes 18a, 18b are arranged. The tubular lamp encloses a discharge chamber 12. The discharge chamber 12 is filled with a gas mixture made of argon and neon (50:50). Within the discharge chamber 12, there is also an amalgam charge 13.

The low pressure amalgam radiator 11 is operated at an essentially constant lamp current. It is distinguished by a nominal power of 200 W (at a nominal lamp current of 4.0 A), an illuminated length of 50 cm, a radiator outer diameter of 28 mm, and a power density of approximately 4 W/cm.

The low pressure amalgam radiator 11 is operated using the electronic ballast 14, which is connected to the low pressure amalgam radiator 11 via the connecting lines 20. The electronic ballast 14 also has a power grid voltage connection 19. During operation the electronic ballast 14 determines the actual values of the lamp voltage U_{L} and the lamp current I_{L} by integrated voltage sensors.

The electronic ballast 14 provides the determined lamp voltage U_{L} finally as an input signal for the control unit 16. In addition, a memory element 22 in the form of an EEPROM is connected to the low pressure amalgam radiator 11, with a desired value for the lamp voltage determined individually at the factory for the low pressure amalgam radiator 11 being stored on this memory element. The control unit 16 reads out the desired value of the lamp voltage when the low pressure amalgam radiator 11 is switched on. During the operation of the low pressure amalgam radiator 11, the control unit 16 polls the actual value of the lamp voltage U_{L ACTUAL} at regular time intervals, that is at a frequency of 5 min⁻¹.

The control unit 16 compares the actual value of the lamp voltage U_{L ACTUAL} with the desired value U_{L DESIRED} stored in the memory element, determines the deviation of the actual value from the desired value, and outputs a control signal that regulates the cooling power of the axial fan 15.

Since the axial fan 15 continuously cools the low pressure amalgam radiator 11 during the operation of the lamp unit 10, the temperature of the low pressure amalgam radiator 11 can, for example, be relatively cooled by an increase in the fan speed or relatively heated by a decrease in the fan speed.

The diagram in FIG. 2 shows the UV emission UV output and the lamp voltage U_{L} of the low pressure amalgam radiator 11 according to FIG. 1 during air cooling with constant air quantity as a function of the air temperature. Both the UV emission and also the lamp voltage were determined simultaneously for the low pressure amalgam radiator. The abscissa plots the air temperature T in ° C. On the right-hand ordinate of the diagram, the ultraviolet radiation emission “UV output” of the low pressure radiator is plotted in mW/cm², while the left-hand ordinate of the diagram plots the lamp voltage U_{L} in volts.

The temperature dependency of the UV emission is described by the curve profile 1. Consequently, with this radiator, a maximum radiation emission (I) of 0.252 mW/cm² at an operating temperature (II) of 52.5 C is obtained.

Furthermore, the curve profile of the lamp voltage as a function of temperature is described by Curve 2. An operating temperature (III) of 52.5° C. thus corresponds to a lamp voltage of 108.6 V. It corresponds to a maximum emission output of the low pressure amalgam radiator 11.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-6. (canceled)

7. A method for operating a lamp unit for generating ultraviolet radiation, the lamp unit including a gas discharge lamp having a discharge chamber accessible for a mercury charge, an electronic ballast, and a temperature control element adjustable by a control unit for controlling a temperature of the gas discharge lamp, wherein the gas discharge lamp is operated with a lamp current and a lamp voltage, and wherein during an operating phase an essentially constant lamp current is applied to the gas discharge lamp, wherein the temperature control element is a cooling element for cooling the gas discharge lamp, and wherein the method comprises the following method steps:
(a) determining an actual value of the lamp voltage by a voltage sensor,
(b) transmitting the actual value of the lamp voltage to the control unit,
(c) comparing the actual value with a desired value of the lamp voltage by the control unit,
(d) outputting a control signal by the control unit to the cooling element for setting a cooling power, and
(e) continuously cooling the gas discharge lamp by the cooling element during operation of the lamp unit.

8. The method according to claim 7, wherein the electronic ballast includes the voltage sensor and determines the actual value of the lamp voltage.

9. The method according to claim 7, wherein the desired value of the lamp voltage for each gas discharge lamp is determined individually at the factory, wherein the individually determined desired value is stored in a memory element connected to the gas discharge lamp, and wherein the memory element is read out by the control unit when the gas discharge lamp is switched on.

10. The method according to claim 9, wherein the memory element is an electronic memory element.

11. The method according to claim 7, wherein the actual value of the lamp voltage is determined at regular time intervals during operation of the lamp unit at a frequency of 1 min⁻¹ to 10 min⁻¹, while the lamp unit is operating.

12. The method according to claim 7, wherein the gas discharge lamp is cooled with an air current generated by the cooling element.
